(19) United States
(12) Patent Application Publication
(10) Pub. No.: US 2007/0210060 A1
(43) Pub. Date: Sep. 13, 2007

(54) Electric oven

(76) Inventor: Ming-Tsung Lee, Tainan City (TW)

Correspondence Address: Ming-Tsung LEE, P.O. BOX 90, Tainan City, 70499, TW

(21) Appl. No.: 11/364,206

(22) Filed: Mar. 1, 2006

(51) Int. Cl. F27D 11/00

(52) U.S. Cl. 219/433

(57) ABSTRACT

An electric oven includes a body, a food container and a lid covered on the food container. The body includes an outer body and an inner body combined together, with a heat-insulating layer formed between the outer and the inner body. A heating tube and a heat preserving material are deposited in the heat-insulating layer, and the heating tube is laid around on an outer wall of the inner body. A bottom plate is fixed with the bottom of the body; a turning switch for setting heating temperature and time is fixed on an outer surface of the outer body, electrically connected with the heating tube and a power source. The food container has an upper flange to be supported on an upper circumferential edge of the inner body for food to be placed therein for roasting and two grip members for taking the food container off the body.

### BACKGROUND OF THE INVENTION

1. Field of the Invention

This invention relates to an electric oven, particularly to one structured to be used both for roasting and boiling, having double functions for cooking.

2. Description of the Prior Art

For roasting food such as a chicken, the food is generally placed in a roasting plate and put in an oven to be roasted with the heating time and temperature preset, and then the oven is started for roasting. As the heat in the oven and the roasting plate for food being roasted are very hot so a user has to wear a heat insulating glove for taking out the roasted food, or otherwise a user's hand might be scolded in case of carelessness. Further, conventional ovens can only be used only for roasting.

### SUMMARY OF THE INVENTION

The purpose of the invention is to offer a kind of oven with a structure so that a roasted food can be taken out conveniently, and the oven can be used for roasting and boiling as well.

The feature of the invention is a body composed of an outer body and an inner body with a heat-insulating layer formed between the outer and the inner body, and then a heating tube and heat preserving material are deposited in the heat-insulating layer. A bottom plate is combined with the bottom of the body, and a turning switch for adjusting heating temperature and time is fixed on an outer surface of the body, and a food container with an upper flange is placed in the body, with the upper flange supported on an upper circumferential edge of the body, with a lid covered on the food container, which is further provided with two grips for taking off the body.

### BRIEF DESCRIPTION OF DRAWINGS

This invention will be better understood by referring to the accompanying drawings, wherein:

FIG. 1 is an exploded perspective view of an electric oven in the present invention;

FIG. 2 is a perspective view of the electric oven in the present invention;

FIG. 3 is a cross-sectional view of the electric oven in the present invention; and,

FIG. 4 is a perspective view of a food container with a food placed therein and a body in the present invention.

### DETAILED DESCRIPTION OF THE PREFERRED EMBODIMENT

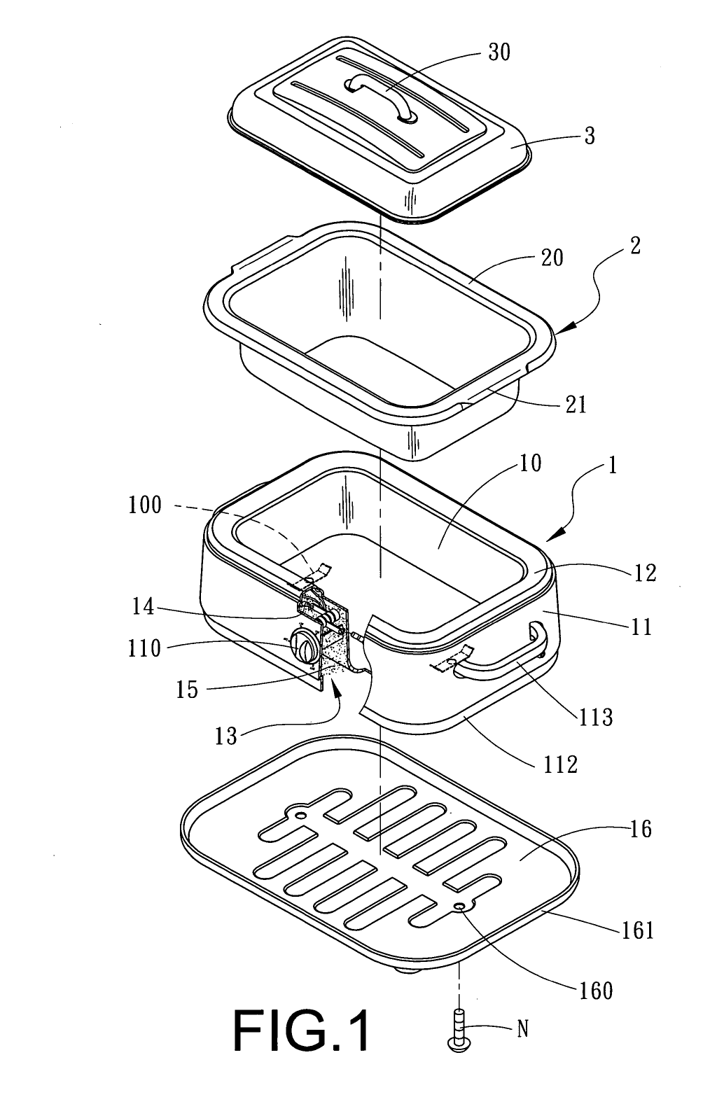

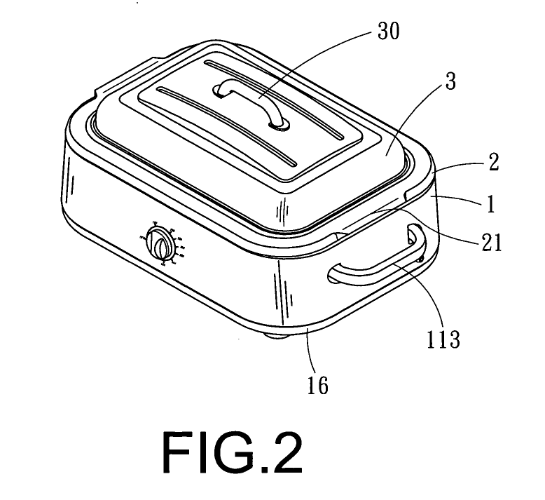

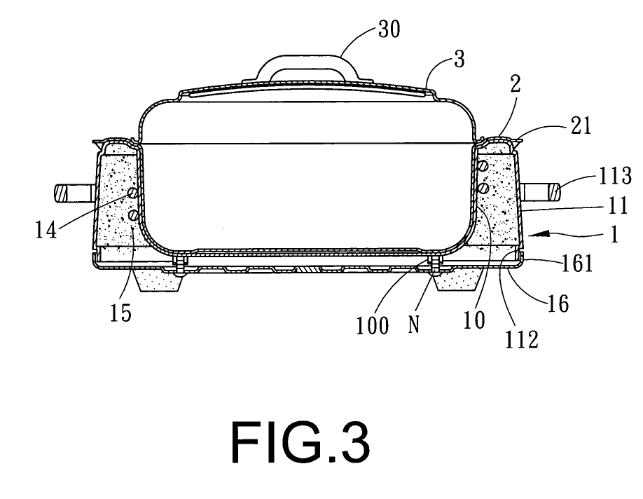

A preferred embodiment in the present invention, as shown in FIGS. 1, 2 and 3, includes a body 1, a food container 2 and a lid 3 as main components.

The body 1 is composed of an inner body 10 and an outer body 11 combined together, and the inner body 10 has a recessed hollow space and an upper circumferential edge 12. Then a heat insulating layer 13 is formed between the inner body 10 and the outer body 11 after combined together so that a heating tube 14 and heat preserving material 15 can be deposited in the heat insulating layer 13, with the heating tube 14 laid around on an outer wall of the inner body 10. Further, a bottom plate 16 is combined with the bottom of the body 1, and provided with plural combining members 100 and a circumferential edge 161. Further a turning switch 110 is fixed on an outer wall of the outer body 11, connected with the turning switch 110 and a power electrically for setting the heating temperature and time needed. An insulating member is provided wrap around the connecting point of the heating tube 14 and the turning switch 110, and the outer body 11 is provided with a recessed bottom edge 112 and a handle 113 fixed respectively on two outer opposite sides. The bottom plate 16 is fixed with the outer body 11 with the circumferential edge 161 fitting with the recessed bottom edge 112, by combining the holes 160 of the bottom plate 16 with the combining members 100 of the inner body 10 with screws (N).

The food container 2 is to be placed in the body 1, having an upper flange 20 and a protruding grip member 21 formed respectively at two opposite sides. The upper flange 20 is to be placed on the upper circumferential edge 12 of the body 1.

The lid 3 is to be covered on the food container 2, having a handle 20 fixed on an upper surface.

In assembling, as shown in FIGS. 1, 2 and 3, the bottom plate 16 is combined with the outer body 11 by letting the circumferential edge 161 of the bottom plate 16 fit with the recessed bottom edge 112 of the outer body 11, letting the holes 160 of the bottom plate 16 facing to the combining members 100 of the inner body 10 and then screwed tightly together with the screws (N), finishing assembling of the electric oven.

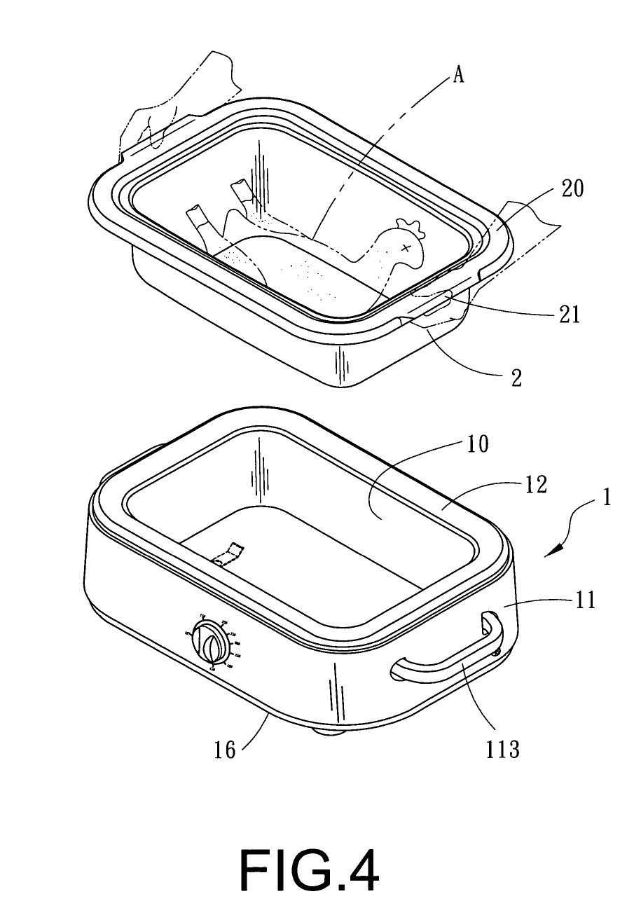

In using, as shown in FIG. 4, a food (A) such as a chicken to be roasted is placed in the food container 2, and then the food container 2 is placed in the body 1, with the upper flange 20 supported on the upper circumferential edge 12 of the inner body 10. Then the lid 3 is covered on the food container 2. The turning switch 110 is handled to adjust the needed temperature and time for roasting the chicken and then the heating tube 14 is turned on for roasting. Then the lid 3 is taken off after finishing roasting, and then the food container 2 is taken out of the body 1, with the roasted chicken ready to be removed out of the food container 2.

It is to be noted that the food container 2 can be taken out of the body 1, with the two grip members 21 held by two hands, more convenient and safer than a conventional electric oven in use.

Further, the food container 2 can be made of metal or porcelain, and if made of metal, the food container 2 can transmit heat swiftly, useable for quick roasting with high temperature. If the food container is made of porcelain, it can be used for slow boiling with low temperature by means of the turning switch 110. So the electric oven according to the invention has double functions, roasting and boiling, quite practical for use.

While the preferred embodiment of the invention has been described above, it will be recognized and understood that various modifications may be made and the appended claimed are intended to cover all such modifications that may fall within the spirit and scope of the invention.

What is claimed is:

1. An electric oven comprising:
a body composed of an outer body and an inner body, said inner body provided with an upper circumferential edge, a heat insulating layer formed between said outer body and said inner body, a heating tube and a heat insulating material deposited in said heat insulating layer, a bottom plate provided under and fixed with said body, said heating tube laid around on an outer wall of said inner body, a turning switch for setting heating temperature and time fixed on an outer wall of said outer body;
a food container placed in said body and having an upper flange to be supported by said circumferential edge of said inner body and a protruding grip member formed respectively at two opposite sides of said upper flange; and,
a lid covering on said food container.

2. The electric oven as claimed in claim 1, wherein said inner body is provided with plural combining members, said turning switch and said heating tube are connected with each other with wires and with a power source, said turning switch handled for adjusting the heating temperature and time for heating said heating tube, an insulating member wrapped around the connecting point of said heating tube and said turning switch, said outer body provided with a recessed circumferential edge at the bottom, said bottom plate having a circumferential edge, said bottom plate provided with plural holes for screws to fasten said bottom plate with said combining members of said inner body for keeping said circumferential edge of said bottom plate fitting with said recessed circumferential edge of said outer body.

3. The electric oven as claimed in claim 1, wherein said outer body is provided with a handle respectively at two opposite outer walls.

4. The electric oven as claimed in claim 1, wherein said food container is made of a metal.

5. The electric oven as claimed in claim 1, wherein said food container is made of porcelain.

6. The electric oven as claimed in claim 1, wherein said lid is provided with a handle on its upper surface.
